(19) United States
(12) Patent Application Publication
(10) Pub. No.: US 2016/0286401 A1
(43) Pub. Date: Sep. 29, 2016

(54) MOTION BASED UNLOCKING METHOD FOR ELECTRONIC DEVICES

(71) Applicant: Saginaw Valley State University, University Center, MI (US)

(72) Inventors: Khandaker Abir Rahman, Saginaw, MI (US); Dustyn James Tubbs, Midland, MI (US)

(21) Appl. No.: 15/071,928

(22) Filed: Mar. 16, 2016

Related U.S. Application Data
(60) Provisional application No. 62/139,613, filed on Mar. 27, 2015.

(51) Int. Cl. H04W 12/08; G01P 13/00

(52) U.S. Cl. CPC H04W 12/08; G01P 13/00; H04W 88/02

(57) ABSTRACT

A method of unlocking a mobile electronic device and as an embodiment unlocking a non-movable electronic device which is interactive with the mobile device using a motion pattern performed on the mobile device is disclosed. The mobile electronic device includes a motion measure unit, a motion pattern storage unit, and a controller. The motion measure unit measures a first motion pattern of the mobile electronic device. The motion pattern storage stores a second motion pattern set for the mobile electronic device based on multiple inputs to set the security pattern. When the first motion pattern of the mobile electronic device measured by the motion measure unit coincides with the second motion pattern stored in the motion pattern storage, the controller executes an unlock of the mobile terminal and if desired, the unlocking of a non-mobile electronic device communicating with the mobile electronic device.

### CROSS-REFERENCE TO RELATED APPLICATION AND CLAIM OF PRIORITY

The present application is related to and claims the benefit of U.S. Provisional application Ser. No. 62/139,613, filed on Mar. 27, 2015, the contents of which are herein incorporated by reference.

### TECHNICAL FIELD OF THE INVENTION

The present disclosure relates to unlocking technology using mobile electronic devices (such as smart phones, tablets, microcontrollers, watches and the like) that provide feedback to the user to unlock said device and or another device that interfaces with said mobile electronic device, such as a personal computer interfacing with a microcontroller.

### BACKGROUND OF THE INVENTION

With the advent of smart mobile computing devices such as smartphone, tablet, smart watch, people are interconnected in more ways than ever before. From their mobile devices, a user can: maintain their social connections through texting, phone calls, or various social media, shop through online retailers, manage their banking accounts, or even process business transactions. With this information, there is clearly a need to ensure only an authorized user can access the device and or various functions of the device such as screen unlock and the like.

### SUMMARY OF THE INVENTION

The present invention is directed to a method and system providing more secure unlocking of mobile electronic devices or using the method to unlock a non-mobile device by using this method to provide authorization authority to a mobile device that communicates with a non-mobile device. A user with a mobile device unlocks a computer by moving the mobile device, the device giving feedback to the user that they can unlock the computer, then the device interfacing with the computer to unlock it. The present invention is an electronic device unlocking method through which a user moves a mobile electronic device in a preset way (pattern) to unlock the mobile device and or a non-mobile electronic device that interfaces with the mobile device. Moving the mobile electronic device in a particular way acts like a password. The invention uses sensory data given off by at least one motion observation sensor(s) such as, an accelerometer, a linear accelerometer, a gyroscope, and an orientation sensor e.g. a tilt-sensor which come built-in with many state-of-the-art mobile electronic devices or can be installed in a microcontroller board (e.g. Arduino, Xilinx brand boards). An aspect of the present disclosure is to provide a mobile electronic device for executing a terminal and or screen unlock based on a motion of the device and a method thereof, capable of reinforcing security of personal information stored in the terminal.

In accordance with another aspect of the present disclosure, a mobile electronic device e.g. terminal, for executing screen unlock, or unlock of other functions based on a motion is provided.

The terminal includes a motion measure sensor for measuring a motion pattern of the mobile device, a motion pattern storage unit for storing a second motion pattern set, and a controller for, when a motion pattern performed on the device coincides with the motion pattern(s) stored in the motion pattern storage unit, executing a device unlock of the mobile device or other function of the mobile device and or providing authorization for another electronic device, e.g. a non-mobile electronic device, that can communicate with the mobile device.

### BRIEF DESCRIPTION OF THE DRAWINGS

For a more complete understanding of the present disclosure and its advantages, reference is made to the following description taken in conjunction with the accompanying drawings, in which like reference numerals represent like parts.

FIG. 1 is a flowchart showing a high level view of the entire process showing the steps from training to unlocking a device.

FIG. 2 is a flowchart showing the steps of training (setting the motion password) process by checking an arbitrarily selected axis of an arbitrarily selected motion sensor. In FIG. 2 the following symbols have the following meanings: M: Decision Threshold: MD; Manhattan Distance; X̅_̅{̅M̅D̅}̅: Average MD; S_{MD}: Sample Standard deviation for MD and X̅T̅e̅s̅t̅S̅a̅m̅p̅l̅e̅_̅{̅M̅D̅}̅: Average MD for an input test sample.

FIG. 3 is a flowchart showing the process to determine whether an arbitrary motion sample fits within the training paradigm (password) of the device used in the embodiment discussed in the specification to unlock a mobile device.

FIG. 4 is a flowchart showing the process to determine whether an arbitrary motion sample fits within a training paradigm (password) to unlock a non-mobile electronic device.

### DETAILED DESCRIPTION OF THE INVENTION

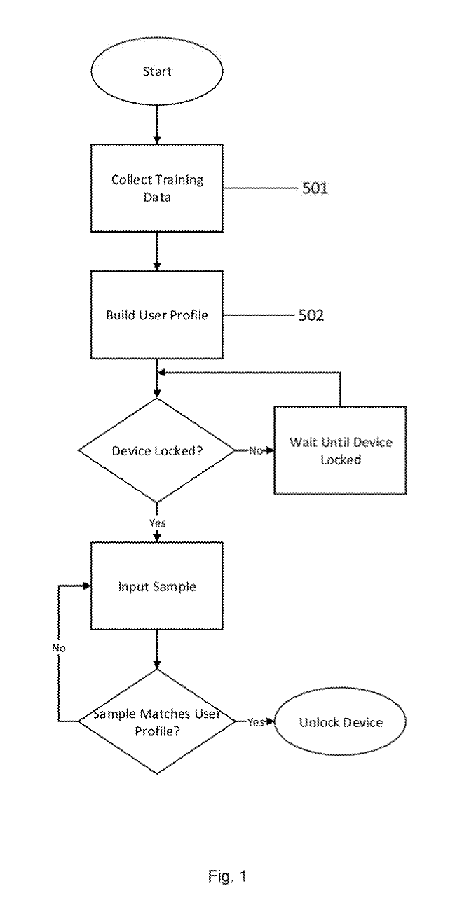

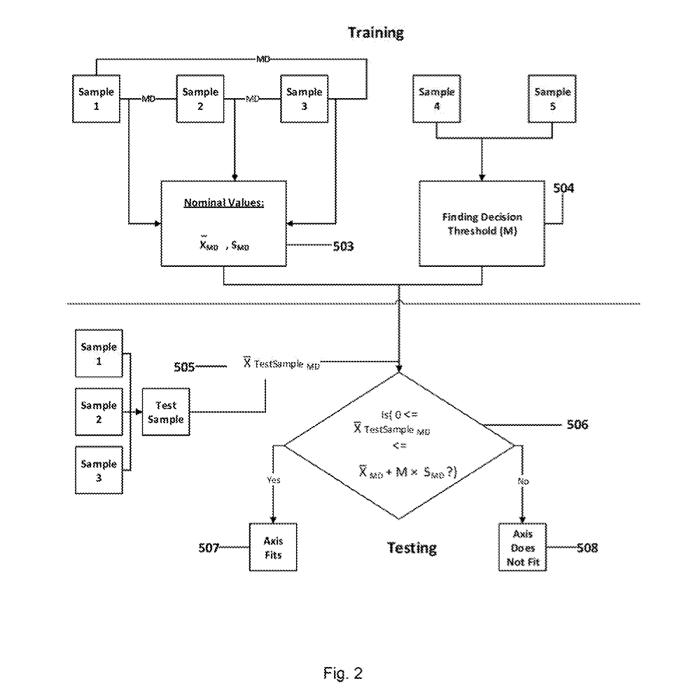

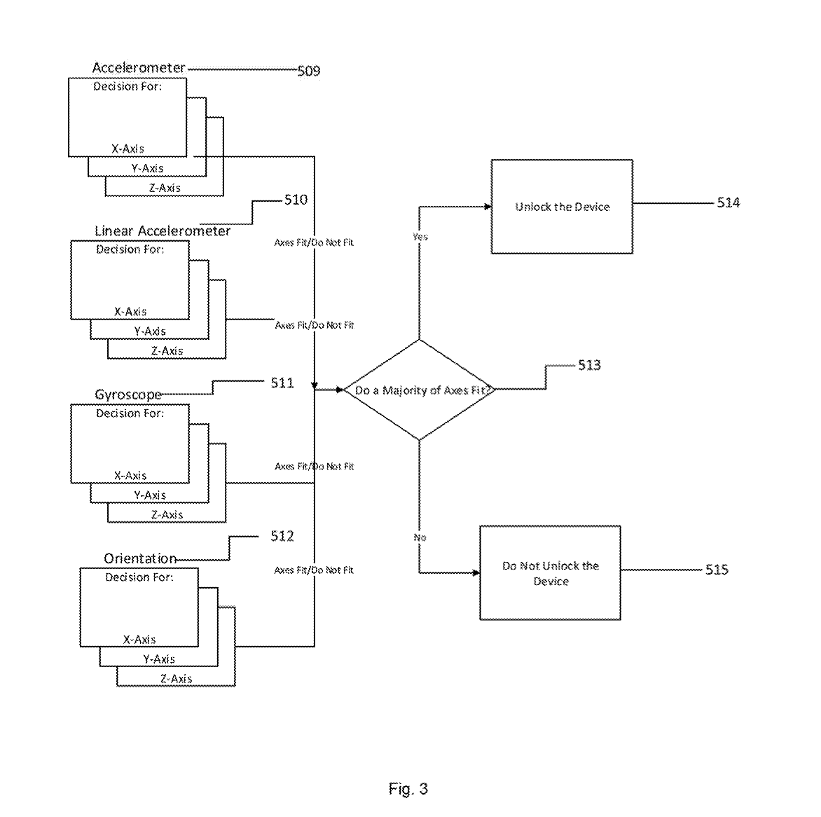

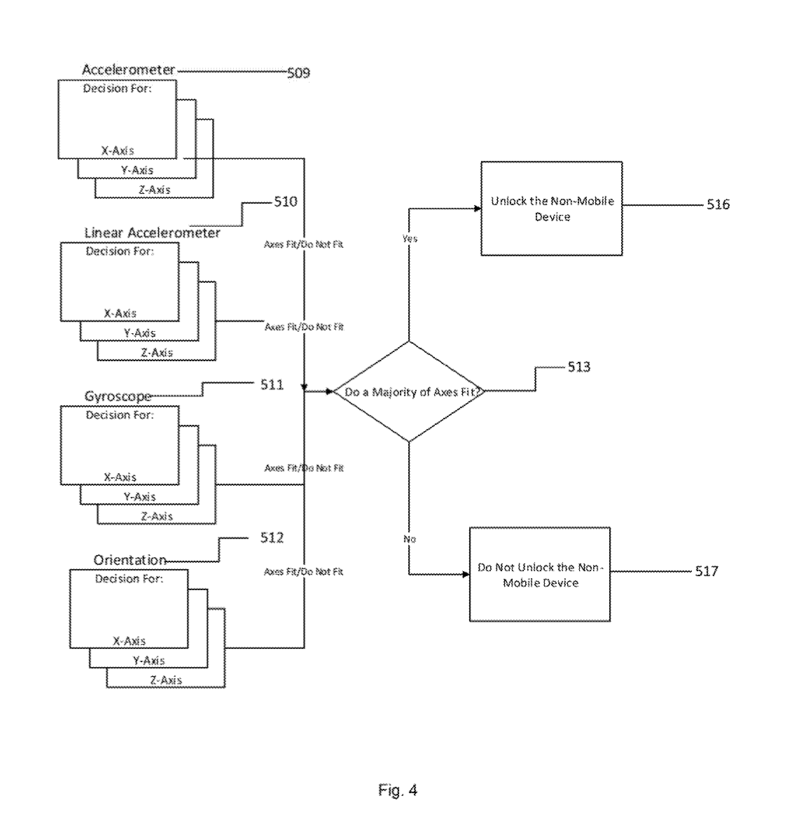

FIG. 1, FIG. 2, FIG. 3 and FIG. 4, are discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged communication system.

The following description with reference to the accompanying drawings is provided to assist in a comprehensive understanding of exemplary embodiments of the disclosure as defined by the claims and their equivalents. The present disclosure includes various specific details to assist in that understanding but these are to be regarded as merely exemplary. Those of ordinary skill in the art will recognize that various changes and modifications of the embodiments described herein can be made without departing from the scope and spirit of the disclosure. Also the following description of exemplary embodiments of the present disclosure are provided for illustration purpose only and not for the purpose of limiting the disclosure as defined by the appended claims and their equivalents.

The present invention may be used with a mobile electronic device such as, for example, a smart phone, smart watch, tablet and the like or may be used in a mobile electronic device which interfaces with a non-mobile electronic device such as for example a personal computer or point of sale terminal. The mobile electronic device contains a non-empty set (at least one) of motion detecting sensors such as but not limited to, accelerometers, gyroscopes, linear accelerometers, orientation sensors e.g. tilt sensors. The mobile device used in the specific embodiments discussed hereafter contained one each of these four different types of motion sensors.

The mobile electronic device includes a motion sensor unit, a motion pattern storage unit, and a controller. Preferably the mobile electronic device includes a least two motion sensors of the types previously discussed and more preferably four motion sensors. Examples of mobile electronic devices include Personal Digital Assistant (PDA), a cellular phone, a smart phone, a notebook, a tablet, activity tracker such as a FITBIT Brand tracker, etc. classified for each terminal type, and a mobile communication terminal such as a Personal Communication Service (PCS) phone, a Global System for Mobile communications (GSM) phone, a Wideband Code Division Multiple Access (W-CDMA) phone, a CDMA-2000 phone, a Mobile Broadband System (MBS) phone, etc. classified for each communication scheme, but also a mobile terminal such as a MP3 player, a Portable Multimedia Player (PMP), a Play Station Portable (PSP), activity tracker, microcontroller, etc. A display screen may be included in the mobile electronic device but is not necessary. The motion measure sensor may measure a motion direction of the mobile device and a change of a velocity, an acceleration, an angular velocity, an angular acceleration, an amount of change in a slope, and an amount of change in a motion distance with respect to a relevant motion direction using a motion measure sensor such as a slope sensor, a gravity sensor, a velocity sensor, an acceleration sensor, an angular velocity sensor, a gyro sensor, etc. For example, when using the velocity sensor, an amount of change in a motion distance may be calculated using an actual measured time with respect to a measured velocity, and an acceleration may be calculated based on an amount of change in velocity per unit time.

A motion pattern storage unit stores a motion pattern (password) set for the mobile electronic device which is to be unlocked or is to unlock another electronic device, such as a non-mobile electronic device that is interactively connected to, i.e. communicates with the mobile electronic device. The mobile electronic device may be used as an electronic key to unlock another device. For example a user may have a smart watch that is connected to a non-mobile computer via blue tooth, wireless internet or some other form of connection, and the watch is moved to reflect the motion password, and the watch provides feedback (for example in the form of a blinking light, vibration or sound) thereby letting the user know that the pattern matched and they can then access the non-mobile computer. Non-mobile means that the device is not easily rotated, moved back and forth, tilted etc. in order to engage the motion password. The password may comprise an x-axis direction of back and forth direction, an y-axis direction of left and right direction, and a straight direction of a z-axis of up and down direction with respect to the device as basic directions, and set and store a motion pattern which in order of positive x-axis direction-negative x-axis direction-negative z-axis direction-positive y-axis direction are executed with respect to the set basic directions. Preferably the password is set using at least two and preferably more than two different patterns, completed in a specific order and within a certain time to provide greater security. Other patterns such as rotation back and forth around the vertical axis or otherwise may be used.

The controller compares a motion of the mobile electronic device measured by the motion measure unit with a motion pattern password stored in the motion pattern storage unit. When the motion of the mobile device coincides with the motion pattern stored in the motion pattern storage unit, the controller may unlock the screen of the mobile terminal, may unlock the device itself or be used to unlock other functions of the device such as certain memory locations, or a connected non-mobile terminal and the like. The non-mobile device and mobile device can be connected through blue tooth, wireless internet or some other form of connection.

Referring to FIG. 1, the method comprises collecting training data Step 501, yielding Samples 1 through 5 referred to in FIG. 2, building a user profile from the training data i.e. a password, Step 502 in FIG. 1, accomplished by Steps 503 and 504 in FIG. 2 and locking a mobile device from intrusion until an input sample matches the password. The process can be broken down into two discrete parts in developing a “motion password” for the user: Training and Testing. In Training, a user inputs data (one or preferably more than one sample pattern) of their “motion password”, which is recorded and used to provide a user profile. An embodiment used five samples but more or less can be used. At the minimum, it is preferred to have at least five samples. In a specific embodiment a mobile electronic device has four motion sensors (either logical or physical) as shown 509-512, FIGS. 3 and 4: An Accelerometer 509 to record acceleration with timestamps in the X, Y, and Z axis of the device; A linear Accelerometer 510 to record linear acceleration with timestamps in the X, Y, and Z axis of the device: A Gyroscope 511 to record angular velocity with timestamps in the X, Y, and Z axis of the device; and an Orientation Sensor (a Tilt Sensor) 512 to record orientation with timestamps in the Azimuth, Pitch and Roll directions of the device.

Initial training Step 502, as shown in FIG. 1, comprises a particular embodiment to build the user's profile by comparing the first three samples Step 503, FIG. 2 of a motion pattern using the Manhattan Distance (MD). The cumulative Manhattan Distance is defined as Σᵢ₌₁^{Min(Length of Sample M,Length of Sample N)}|Mᵢ−Nᵢ| where, Mᵢ and Nᵢ are sensor readings at a certain time i.e., from “SampleM” and “SampleN” respectively. For the particular embodiment discussed, a record is made with each sensor: a time stamp, value on the X-Axis, value on the Y-Axis, and value on the Z-Axis (or Azimuth, Pitch, and Roll for the Orientation).

For the particular embodiment discussed, a total of 36 (4 sensors×3 axes×3 sample comparisons: Sample 1-Sample 2, Sample 2-Sample 3 and Sample 3-Sample 1)) MDs are used to yield the average values X̅_{MD} and standard deviation, S_{MD} in Step 502, for each axis of each sensor of that pattern to build the user profile. An initial range for expected values, 0 (for perfect match) to X̅_{MD}+S_{MD}, was chosen to provide a range the first three samples are expected to fit. The range is then adjusted by a factor M (values may range from 0 to 3 with a possible step size of 0.001) in Step 504 to set a decision threshold so that it will be limited by the values from Sample 4 and Sample 5, Step 504, FIG. 2 which will complete the system training i.e. setting the password. Overall, the range of acceptance will be: 0 (for perfect match) to X̅_{MD}+M×S_{MD} (for maximum deviation allowed).

In Step 505, an arbitrary sample i.e. motion password is tested by determining the average MD for that sample against the first three training samples, and comparing that to the range given by the training, Step 506. The decision after comparison comes as either the “Axis Fits” in Step 507 or “Axis Does not Fit” in Step 508. Because that decision process is by axis, this is repeated 12 times (3 axes×4 sensors as shown in Step 509 to Step 512 in FIGS. 3 and 4 for an individual sample. After the process of polling in Step 513, the arbitrary motion sample, i.e., motion password is accepted by the system and system generates an unlock signal in Step 514 (if a majority of the axes fit within the training paradigm i.e. preset password) or rejected if the input does not meet the password, Step 515. In the embodiment where the method and system is used to unlock a non-mobile device as shown in FIG. 4 Steps 516 and 517 present a set of analogous signals for a system and method implemented to unlock a non-mobile device Step 516 or not unlock a non-mobile device Step 517. It is preferred that at least two motion sensors are used in setting a password (Training) and for assessing whether a correct password has been entered it is also preferred that the password should be entered at least twice when unlocking a function of a mobile or non-mobile device, such as activating the device, unlocking a screen or the like.

What is claimed is:

1. A mobile electronic device having a terminal comprising:
at least two motion measure units configured to measure first motion pattern of the terminal using input from all said motion measure units; a motion pattern storage configured to store a non-empty set of second motion pattern(s) for unlocking the terminal wherein the second motion pattern(s) includes a motion pattern having input from both of said motion measure units; and a controller configured to, in response to the first motion pattern matching the second motion pattern unlocking the device.

2. The mobile device of claim 1, wherein the motion measure unit is configured to measure a motion comprising at least two of a motion direction of the terminal, a velocity, an acceleration, an angular velocity, an angular acceleration, an amount of change in a slope, and an amount of a motion distance.

3. A method for unlocking a mobile electronic device, comprising: detecting a first motion pattern of the electronic device wherein the first motion pattern includes a motion pattern resulting from a least two different motion sensors and when the first motion pattern corresponds to a second motion pattern stored in the electronic device for unlocking the electronic device, a controller unlocks at least one function of the mobile electronic device.

4. The method of claim 3 wherein the motion pattern results from more than two different motion sensors.

5. The method of claim 3 wherein the function that is unlocked is the activation of the electronic device.

6. The method of claim 3 wherein the function that is unlocked is unlocking a screen on said device.

7. The method of claim 3 further comprising: when the first motion pattern corresponds to the second motion pattern, outputting a sound effect corresponding an unlock state.

8. The method of claim 3 further comprising when the first motion pattern corresponds to the second motion pattern, outputting a light effect corresponding an unlock state.

9. The method of claim 3 further comprising: when the first motion pattern corresponds the second motion pattern, outputting a vibration effect corresponding an unlock state.

10. The method of claim 3, wherein the first motion pattern of the electronic device comprises at least two successive motion patterns.

11. The method of claim 3, wherein the first motion pattern of the electronic device is determined by at least one of a velocity, an acceleration velocity, an angular velocity, an angular acceleration, an amount of change in a slope, and an amount of a motion distance.

12. The method of claim 3, wherein the first motion pattern of the electronic device is determined by an input of the average of at least two inputs form the at least at least two motion sensors.

13. A method for unlocking and activating a non-mobile electronic device which comprises;
providing communication between a mobile electronic device and said non-mobile electronic device;
providing a password on said non-mobile device based on the motion of said mobile electronic device;
detecting a first motion pattern of the mobile electronic device wherein the first motion pattern includes a motion pattern resulting from a least one motion sensors and when the first motion pattern corresponds to a second motion pattern stored in the electronic device, a controller unlocks at least one function of the mobile electronic device, and
upon unlocking of the mobile electronic device function said unlocking is communicated to the non-mobile device to unlock said non-mobile electronic device.

14. The method of claim 13, wherein the function unlocked on the mobile electronic device is activation of the mobile electronic device.

15. The method of claim 13 wherein the function unlocked on the mobile electronic device is a signal indicating that the non-mobile electronic device is unlocked.
